(19) United States
(12) Patent Application Publication
(10) Pub. No.: US 2008/0058069 A1
(43) Pub. Date: Mar. 6, 2008

(54) SLOT MACHINE AND PLAYING METHOD THEREOF

(75) Inventor: Katsuhiro KIDO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/777,533

(22) Filed: Jul. 13, 2007

(30) Foreign Application Priority Data
Aug. 29, 2006 (JP) 2006-232590

(51) Int. Cl. G07F 17/34; A63F 13/00; A63F 9/24

(52) U.S. Cl. 463/20

(57) ABSTRACT

A slot machine of the present invention includes: a slot machine comprising: a display capable of displaying a plurality of objects moving in a predetermined direction, and a plurality of areas a contact determination of which with each of the plurality of the objects is executed; and a controller, the controller displaying the plurality of the objects and the plurality of the areas to the display, the plurality of the objects displayed in a mode of moving in the predetermined direction, executing a contact determination between each of the plurality of the objects and any of the plurality of the areas, and providing an award according to the object having come into contact with the area.

### CROSS-REFERENCE TO RELATED APPLICATIONS

This application claims benefit of priority based on Japanese Patent No. 2006-232590 filed on Aug. 29, 2006. The contents of this application are incorporated herein by reference in their entirety.

### BACKGROUND OF THE INVENTION

1. Field of the Invention

The present invention relates to a slot machine on which a game is played using game media such as coins, and a playing method of the slot machine.

2. Discussion of the Background

Conventionally, in a facility where slot machines are set up, a game can be played by inserting various types of game media, such as coins or cash, into a slot machine. Then, each slot machine is configured to provide an award according to a winning state (game result) occurring as a result of the progress of a game (see U.S. Pat. No. 6,960,133, for example).

Further, although in conventional slot machines it is common practice that a winning line is a straight line, there also appears a slot machine having a variety of winning lines other than such a straight winning line and a slot machine that has no concept of a winning line.

Examples of a slot machine whose winning line is not limited only to a straight line include, for example, a slot machine described in U.S. Pat. No. 6,093,102. However, a slot machine that provides an award when a predetermined number of symbols stops within a display to which a winning line and a symbol matrix are displayed has no difference from a slot machine that uses a straight wining line, in terms of a payout value being determined by a result of rearrangement of symbols; accordingly, they have a similar display mode.

An object of the present invention is to provide a slot machine capable of increasing a player's expectation and performing display of game results with excellent entertainment, and a playing method of the slot machine.

The contents of U.S. Pat. Nos. 6,960,133 and 6,093,102 are incorporated herein by reference in their entirety.

### SUMMARY OF THE INVENTION

The present invention provides a slot machine having the following configuration.

Namely, the above-mentioned slot machine comprises: a display capable of displaying a plurality of objects moving in a predetermined direction, and a plurality of areas a contact determination of which with each of the plurality of the objects is executed; and a controller. The controller displays the plurality of the objects and the plurality of the areas to the display, the plurality of the objects displayed in a mode of moving in the predetermined direction, executes a contact determination between each of the plurality of the objects and any of the plurality of the areas, and provides an award according to the object having come into contact with the area.

According to the slot machine of the present invention, a plurality of objects (e.g., a shower of blossom and the like) moves in a predetermined direction and it is determined whether the objects have come into contact with any of a plurality of predetermined areas. Then, an award is provided according to the object having come into contact with the area.

Hence, in the present invention, a payout is determined by a method totally different from that used by conventional slot machines. This enables a display of game results with excellent entertainment, making it possible to increase the player's expectation.

The slot machine of the present invention desirably has the following configuration.

The above-mentioned controller determines a size of the plurality of the areas according to the number of BETs, such that the larger the number of BETs, the larger the size of the plurality of the areas.

According to the slot machine of the present invention, the larger the number of BETs, the larger the size of the area; thus, the possibility that the objects will come into contact with the area increases. Accordingly, it becomes possible to further increase the player's expectation as the number of game media BET by the player increases.

The slot machine of the present invention desirably has the following configuration.

The controller provides an award according to a combination of the plurality of the objects having come into contact with the area.

According to the slot machine of the present invention, an award is provided according to a predetermined combination of objects coming into contact with the area. Accordingly, it becomes possible to further increase a player's expectation as the objects constituting the predetermined combination come into contact with the area.

In addition, the present invention provides a slot machine having the following configuration.

Namely, the above-mentioned controller comprises: a display capable of displaying a plurality of objects moving in a predetermined direction, and a plurality of areas a contact determination of which with each of the plurality of the objects is executed; and a controller. The controller determines a size of the plurality of the areas according to the number of BETs, such that the larger the number of BETs, the larger the size of the plurality of the areas, displays the plurality of the objects and the plurality of the areas to the display, the plurality of the objects displayed in a mode of moving in the predetermined direction, executes a contact determination between each of the plurality of the objects and any of the plurality of the areas, and provides an award according to the object having come into contact with the area.

The slot machine of the present invention desirably has the following configuration.

The above-mentioned controller provides an award according to a combination of the plurality of the objects having come into contact with the area.

Moreover, the present invention provides a slot machine having the following configuration.

Namely, the above-mentioned controller comprises: a display capable of displaying a plurality of objects moving in a predetermined direction, and a plurality of areas a contact determination of which with each of the plurality of the objects is executed; and a controller. The controller determines a size of the plurality of the areas according to the number of BETs, such that the larger the number of BETs, the larger the size of the plurality of the areas, displays the plurality of the objects and the plurality of the areas to the display, the plurality of the objects displayed in a mode of moving in the predetermined direction, executes a contact determination between each of the plurality of the objects and any of the plurality of the areas, and provides an award according to a combination of the plurality of the objects having come into contact with the area.

The present invention provides a playing method of a slot machine having the following configuration.

Namely, the playing method of the above-mentioned slot machine comprises the steps of: displaying, to a display, a plurality of objects in a mode of moving in a predetermined direction and also displaying a plurality of areas a contact determination of which with each of the plurality of the objects is executed; executing a contact determination between the plurality of the objects and any of the plurality of the areas; and providing an award according to the object having come into contact with the area, each of the steps conducted by a controller.

The playing method of a slot machine of the present invention desirably has the following configuration.

The above-mentioned controller determines a size of the plurality of the areas according to the number of BETs, such that the larger the number of BETs, the larger the size of the plurality of the areas.

The playing method of a slot machine of the present invention desirably has the following configuration.

The above-mentioned controller provides an award according to a combination of the plurality of the objects having come into contact with the area.

In addition, the present invention provides a playing method of a slot machine having the following configuration.

The playing method of the above-mentioned slot machines comprises the steps of: determining a size of a plurality of areas according to the number of BETs, such that the larger the number of BETs, the larger the size of the plurality of the areas; displaying, to a display, a plurality of objects in a mode of moving in a predetermined direction and also displaying the plurality of the areas a contact determination of which with each of the plurality of the objects is executed; executing a contact determination between each of the plurality of the objects and any of the plurality of the areas; and providing an award according to the object having come into contact with the area, each of the steps conducted by a controller.

The playing method of a slot machine of the present invention desirably has the following configuration.

The above-mentioned controller provides an award according to a combination of the plurality of the objects having come into contact with the area.

Furthermore, the present invention provides a playing method of a slot machine having the following configuration.

Namely, the playing method of a slot machine comprises the steps of: determining a size of a plurality of areas according to the number of BETs, such that the larger the number of BETs, the larger the size of the plurality of the areas; displaying, to a display, a plurality of objects in a mode of moving in a predetermined direction and also displaying the plurality of the areas a contact determination of which with each of the plurality of the objects is executed; executing a contact determination between each of the plurality of the objects and any of the plurality of the areas; and providing an award according to a combination of the plurality of the objects having come into contact with the area.

According to the present invention, it is possible to provide a slot machine capable of attracting more customers and adding novel entertainment, and a playing method of the slot machine.

### BRIEF DESCRIPTION OF THE DRAWINGS

FIGS. 1A and 1B are views showing an exemplary image displayed to a lower image display panel.

FIGS. 2A and 2B are views showing an exemplary image displayed to the lower image display panel.

FIG. 3 is a perspective view schematically showing a slot machine according to one embodiment of the present embodiment.

FIG. 4 is a block diagram showing the internal configuration of the slot machine shown in FIG. 3.

FIG. 5 is a flowchart showing a subroutine of game execution processing.

FIG. 6 is a flowchart showing a subroutine of object falling processing.

FIG. 7 is a flowchart showing a subroutine of bonus game processing.

### DESCRIPTION OF THE EMBODIMENTS

Embodiments of the present invention will be described with reference to the drawings.

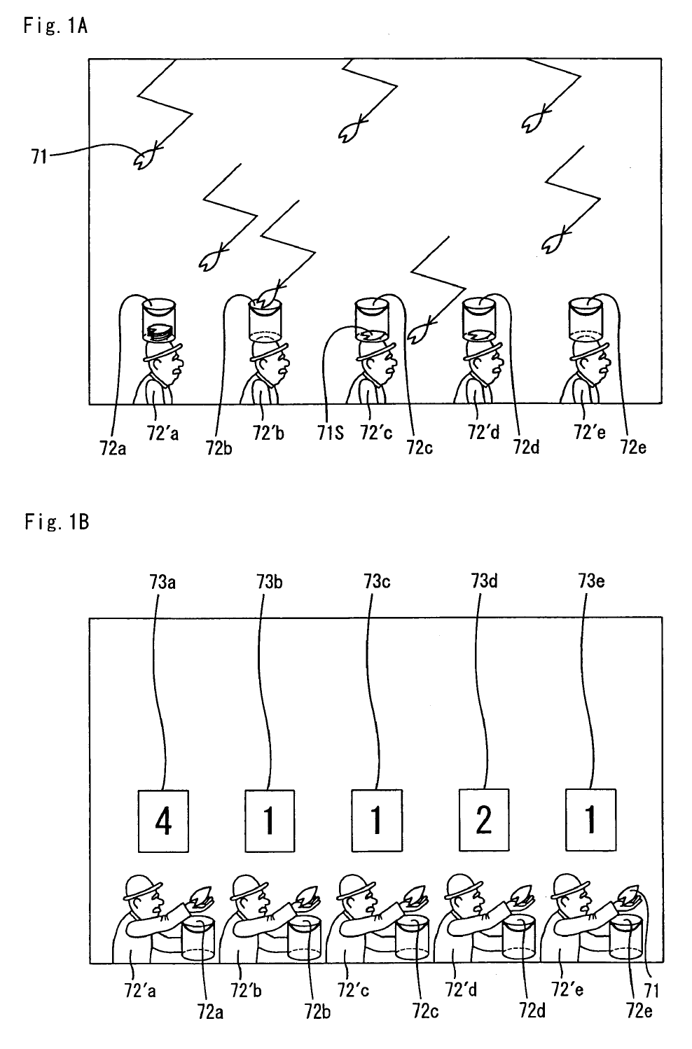

FIGS. 1A and 1B are views showing an exemplary image displayed to a lower image display panel.

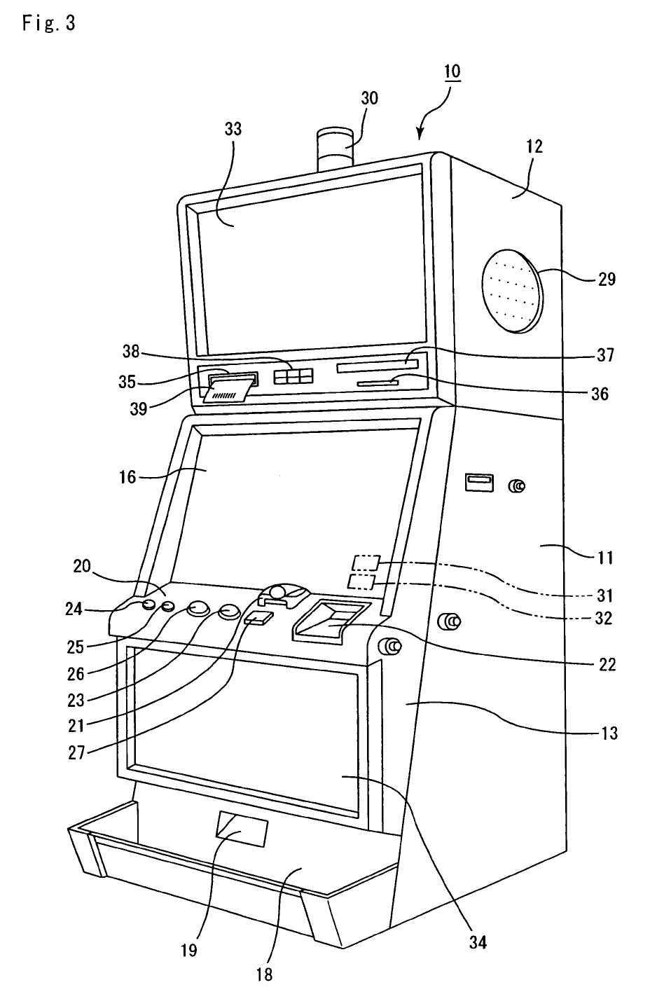

The images shown in FIGS. 1A and 1B are images displayed to a lower image display panel 16 (see FIG. 3) included in a slot machine 10 of the present invention, and there are displayed a plurality of petal-shaped objects 71 and bucket-shaped five targets 72a to 72e respectively placed on the heads of characters 72′a to 72′e. Arrows in the drawings indicate paths along which the objects 71 are move-displayed. The lower image display panel 16 is comprised of a liquid crystal panel.

In the slot machine 10, when a game is started, to the lower image display panel 16, a predetermined number of objects 71 are move-displayed such that the objects 71 fall downward from the top of the screen to the bottom of the screen with the objects 71 moving in left and right directions. Then, it is determined whether or not each of the objects 71 has come into contact with an outer circumference of any of the targets 72a to 72e. The object 71, the outer circumference of which is determined to have come into contact with the outer circumference of the target 72, is accumulated inside the target 72 and displayed therein as an accumulated object 71S. On the other hand, the object 71, the outer circumference of which is determined to have not come into contact with the outer circumference of the target 72, is move-displayed toward the bottom of the screen and then deleted. The outer circumference of the target 72 corresponds to an area according to the present invention. Further, determining whether or not the outer circumference of each of the objects 71 has come into contact with the outer circumference of any of the targets 72 corresponds to a contact determination according to the present invention.

When all of the predetermined number of objects 71 have finished moving, an image such as the one shown in FIG. 1B is displayed. In FIG. 1B, each of the characters 72′a to 72′e counts the number of accumulated objects 71S in the respective targets 72a to 72e. Then, the counted numbers of accumulated objects 71S are displayed at the upper portion of the respective targets 72, as the numbers of accumulated objects 73a to 73e. When three or more numbers among the numbers of accumulated objects 73a to 73e have the same value, coins are paid out in number corresponding to the number of BET coins×the value of the counted numbers of accumulated objects 71S. In the case of the example shown in FIG. 1B, since the values of the numbers of accumulated objects 73b, 73c, and 73e are all 1 and thus are the same value; therefore, coins are paid out in number corresponding to the number of BET coins×1. When all of the numbers of accumulated objects 73a to 73e have the same value, the game shifts to a bonus game. As such, the number of coins to be paid out is determined according to a combination of the numbers of objects 71 which entered each of the targets 72.

In the present embodiment, there has been described the case in which an object 71 has a petal shape and a target 72 has a bucket shape. However, in the present invention, the shapes of the object and the target are not particularly limited. For example, the number of game media to be paid out may be determined according to the number of ball-shaped objects having entered a basket-shaped target.

Further, in the present embodiment, there has been described the case in which a payout is generated when three or more numbers among the numbers of accumulated objects 73a to 73e have the same value. However, in the present invention, the method of determining the number of game media to be paid out is not particularly limited. For example, the sum of the numbers of accumulated objects 73a to 73e may be the number of coins to be paid out. Further, for example, an award may be provided when a predetermined combination is established, such as when the values of the accumulated objects 73a to 73e are all odd or all even.

Also, in the present embodiment, there has been described the case in which the numbers of accumulated objects 73a to 73e are displayed after the move-display of objects 71 is all finished. However, in the present invention, there is no particular limitation on the timing for displaying the numbers of objects 71 having come into contact with the respective targets 72. For example, the numbers of accumulated objects 73a to 73e may be displayed while the objects 71 are move-displayed, and the values of the numbers of accumulated objects 73a to 73e may be changed every time an object 71 enters a target 72.

In the present embodiment, there has been described the case in which a predetermined number of objects 71 are move-displayed per game. However, in the present invention, the number of objects to be move-displayed in a single game is not particularly limited. For example, the number of objects 71 to fall may not be determined in advance but the period of time during which objects 71 are move-displayed may be determined in advance, and the number of game media to be paid out may be determined according to the number of objects 71 accumulated in the targets 72 within such a period of time or according to the proportion of such objects 71 (the number of objects having accumulated in the targets 72/the number of objects move-displayed). Alternatively, the total number of objects to be move-displayed may not be determined, and the move-display may be continued until the number of contacts of those objects with each of those targets reaches a predetermined number, and then a payout value may be determined according to the time required to reach the predetermined number.

Further, in the present embodiment, there has been described the case in which a game shifts to a bonus game when all the numbers of accumulated objects 73a to 73e have the same value. However, in the present invention, a condition for shifting to a bonus game is not particularly limited. For example, the game may be shifted to a bonus game when the total value of the accumulated objects 73a to 73e is equal to or larger than a predetermine value. Furthermore, for example, a game may shift to a bonus game when the values of the numbers of accumulated objects 73a to 73e are arranged in a predetermined regular pattern, such as in order of 1, 2, 3, 4, and 5.

The size of the targets 72 is determined according to the number of BET game media.

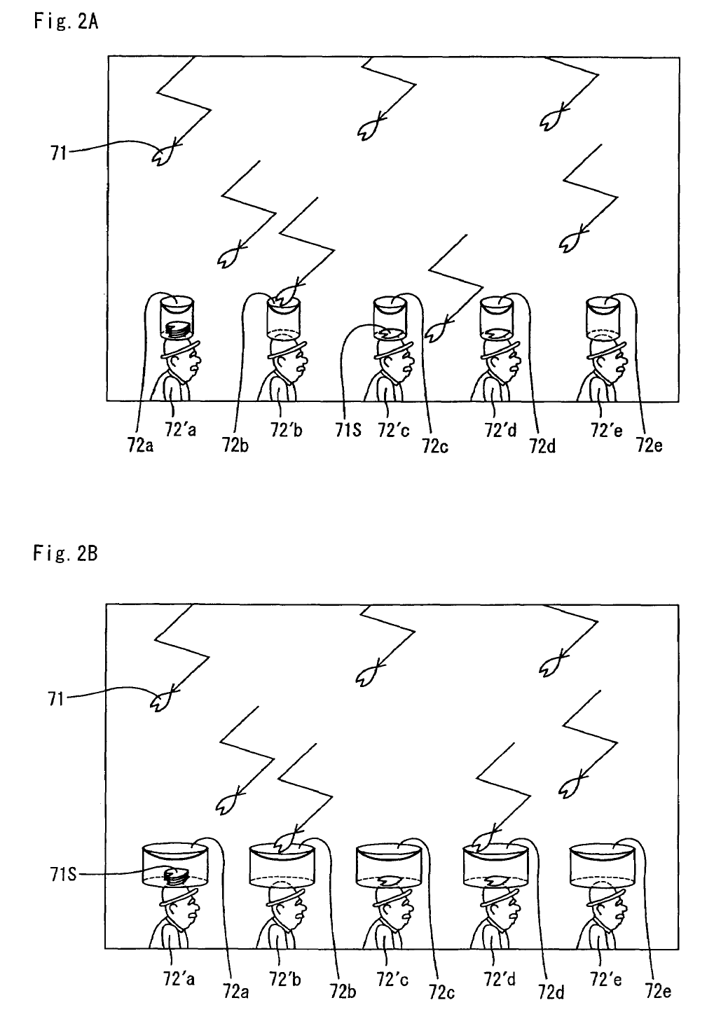

FIGS. 2A and 2B are views showing an exemplary image displayed to the lower image display panel.

FIG. 2A shows an exemplary image to be displayed to the lower image display panel 16 when the number of BET game media is one. On the other hand, FIG. 2B shows an exemplary image displayed to the lower image display panel 16 when the number of BET game media is 50. As such, the larger is the number of BET game media, the larger the size of the targets 72 becomes; this enlarges the area of an area with which a contact determination is executed, whereby the objects 71 enter the targets 72 more easily.

It should be noted that, although the case in which the size of the targets 72 changes according to the number of BET coins in the present embodiment, the number of objects 71, for example, may be changed change according to the number of BET coins in the present invention. By employing such a configuration, as in the case in which the size of the targets 72 changes according to the number of BET coins, it becomes possible that the larger is the number of BET coins, the more easily the objects 71 enter the targets 72.

Next, the configuration of the slot machine 10 will be described.

FIG. 3 is a perspective view schematically showing a slot machine according to one embodiment of the present invention.

In the present embodiment, the slot machine 10 is a video slot machine. However, in the present invention, the slot machine is not limited to a video slot machine, and may be, for example, a mechanical slot machine or the like.

Although the slot machine 10 is a stand-alone slot machine that is not connected to a network, the present invention is also applicable to a slot machine that is connected to a network.

On the slot machine 10, a coin, a bill, or electronic valuable information corresponding thereto are used as a game medium. However, in the present invention, a game medium is not particularly limited, and for example, a medal, a token, electronic money, or a ticket can be used. It should be noted that the above-mentioned ticket is not particularly limited and may include, for example, a ticket with a barcode, as will be described later, and of the like tickets.

The slot machine 10 includes a cabinet 11, a top box 12 installed on the upper side of the cabinet 11, and a main door 13 provided at the front face of the cabinet 11.

A lower image display panel 16 is provided at the front of the main door 13. The lower image display panel 16 comprises a liquid crystal panel to which various types of information on the game, effect images, and the like, are displayed during a game. The lower image display panel 16 functions as a display in the present invention. The lower image display panel 16 included in the slot machine 10 of the present invention is comprised of a liquid crystal panel.

A number-of-credits display portion 31 and a number-of-payouts display portion 32 are set on the lower image display panel 16. To the number-of-credits display portion 31, the number of credited coins is displayed as an image. To the number-of-payouts display portion 32, the number of coins to be paid out when three or more numbers of accumulated 73a to 73e have the same value, is displayed as an image.

Furthermore, a touch panel 69, though not shown, is provided at the front face of the lower image display panel 16. A player can operate the touch panel 69 to input various types of commands.

Below the lower image display panel 16, there are provided a control panel 20 including a plurality of buttons 23 to 27 with each of which a command according to the game progress is inputted by the player, a coin receiving slot 21 through which a coin is accepted into the cabinet 11, and a bill validator 22.

The control panel 20 is provided with a start button 23, a change button 24, a CASHOUT button 25, a 1-BET button 26, and a maximum BET button 27. The start button 23 is used for inputting a command to start move-display of objects 71. The change button 24 is used when making a request of staff in a recreation facility for exchange. The CASHOUT button 25 is used for inputting a command to pay out credited coins to a coin tray 18.

The 1-BET button 26 is used for inputting a command to bet one coin on a game out of credited coins. The maximum BET button 27 is used for inputting a command to bet a maximum number (50 in the present embodiment) of coins that can be bet on a single game, out of credited coins.

It should be noted that, in the present invention, inserting a game medium means betting a game medium on a game. For example, when a coin inserted into the coin receiving slot 21 is directly bet on a game, the insertion of the coin into the coin receiving slot 21 corresponds to the insertion of a game medium. However, as in the present embodiment, in a case in which a coin inserted into the coin receiving slot 21 is credited once and the credited coin is bet on a game by the operation of the 1-BET button 26 or the maximum BET button 27, the betting of the credited coin on the game corresponds to the insertion of a game medium.

The bill validator 22 not only discriminates a regular bill from a false bill, but also accepts the regular bill into the cabinet 11. It should be noted that the bill validator 22 may be configured so as to be capable of reading a later described ticket 39 with a barcode. At the lower front face of the main door 13, namely below the control panel 20, there is provided a belly glass 34 on which a character or the like of the slot machine 10 is drawn.

An upper image display panel 33 is provided at the front face of the top box 12. The upper image display panel 33 comprises a liquid crystal panel to display, for example, an image representing an introduction of the content of a game and explanation of a rule of the game.

In the present embodiment, there has been described the case in which both the lower image display panel 16 and the upper image display panel 33 comprise a liquid crystal panel. However, in the present invention, the above-mentioned image display panels may comprise any other display such as a CRT (Cathode Ray Tube) or a plasma display.

Further, the top box 12 is provided with a speaker 29. Below the upper image display panel 33, there are provided a ticket printer 35, a card reader 36, a data display 37, and a keypad 38. The ticket printer 35 prints on a ticket a barcode as coded data of the number of credits, date and time, an identification number of the slot machine 10, and the like, and outputs the ticket as a ticket 39 with a barcode. The player can make another slot machine read the ticket 39 with a barcode to play a game thereon, or exchange the ticket 39 with a barcode with a bill or the like at a predetermined place in the recreation facility (e.g. a cashier in a casino).

The card reader 36 reads data from a smart card and writes data onto the smart card. The smart card is a card owned by the player, and for example, data for identifying a player and data concerning a history of games played by the player are stored. Data corresponding to a coin, a bill, or a credit may be stored in the smart card. Further, a magnetic stripe card may be adopted in place of the smart card. The data display 37 is comprised of a fluorescent display or the like, and displays, for example, data read by the card reader 36 and data inputted by the player through the keypad 38. The keypad 38 is used for inputting a command and data concerning the issue of a ticket, and the like.

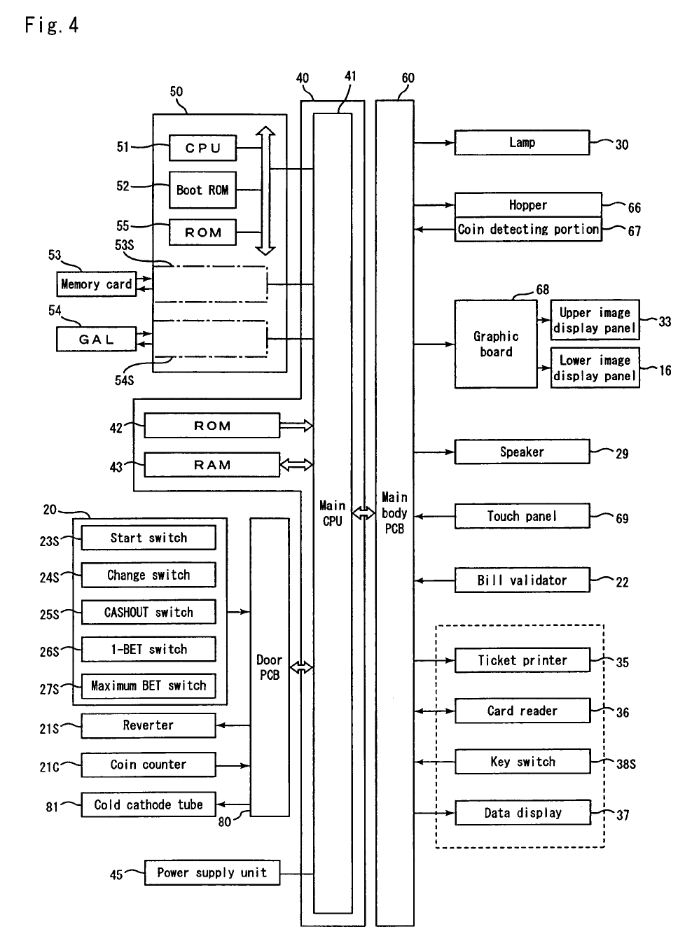

FIG. 4 is a block diagram showing the internal configuration of the slot machine shown in FIG. 3.

A gaming board 50 includes a CPU (Central Processing Unit) 51, a ROM 55, and a boot ROM 52 which are interconnected to one another via an internal bus, a card slot 53S corresponding to a memory card 53, and an IC socket 54S corresponding to a GAL (Generic Array Logic) 54.

The memory card 53 is comprised of a nonvolatile memory such as Compact Flash (registered trademark), and stores a game program. The game program includes an object falling program. The object falling program is a program for move-displaying objects 71 such that the objects 71 fall.

Further, the card slot 53S is configured so as to allow the memory card 53 to be inserted there into or ejected therefrom, and is connected to a mother board 40 via an IDE bus. Thus, the memory card 53 can be ejected from the card slot 53S, and then another game program is written onto the memory card 53, and the memory card 53 can be inserted into the card slot 53S, to change the type and contents of a game played on the slot machine 10. The game program includes a program according to the game progress. Also, the game program includes image data and sound data to be outputted during the game.

The CPU 51, the ROM 55, and the boot ROM 52, which are interconnected to one another via the internal bus, are connected to the mother board 40 via a PCI bus. The PCI bus not only conducts signal transmission between the mother board 40 and the gaming board 50, but also supplies power from the mother board 40 to the gaming board 50.

The mother board 40 is configured using a commercially available general-purpose mother board (a printed wiring board on which fundamental components of a personal computer are mounted), and comprises a main CPU 41, a ROM (Read Only Memory) 42, a RAM (Random Access Memory) 43, and a communication interface 44. The mother board 40 has a function as a controller in the present invention.

The ROM 42 is comprised of a memory device such as a flash memory, and stores a program such as BIOS (Basic Input/Output System) executed by the main CPU 41, and permanent data. When the BIOS is executed by the main CPU 41, processing for initializing predetermined peripheral devices is conducted, concurrently with processing for loading a game program stored in the memory card 53 through the gaming board 50. It should be noted that, in the present invention, the ROM 42 may or may not be a content rewritable one.

The RAM 43 stores data and programs which are used at the time of operation of the main CPU 41. Further, the RAM 43 is capable of storing a game program.

In addition, the RAM 43 stores data on the number of credits, the number of coin-ins and coin-outs in a single game, and the like.

Moreover, a main body PCB (Printed Circuit Board) 60 and a door PCB 80, which will be described later, are connected to the mother board 40 through respective USBs. Furthermore, the mother board 40 is connected with a power supply unit 45.

The main body PCB 60 and the door PCB 80 are connected with equipment and devices that generate input signals to be inputted to the main CPU 41 and equipment and devices operations of which are controlled by control signals outputted from the main CPU 41. The main CPU 41 executes a game program stored in the RAM 43 based on an input signal inputted to the main CPU 41, and thereby executes the predetermined arithmetic processing, and stores a result thereof in the RAM 43, or transmits a control signal to each of the equipment and devices as processing for controlling each of the equipment and devices.

A lamp 30, a hopper 66, a coin detecting portion 67, a graphic board 68, a speaker 29, a touch panel 69, a bill validator 22, a ticket printer 35, a card reader 36, a key switch 38S, and a data display 37 are connected to the main body PCB 60. The lamp 30 lights up in a predetermined pattern based on a control signal outputted from the main CPU 41.

The hopper 66 is installed inside the cabinet 11, and pays out a predetermined number of coins from a coin payout exit 19 to the coin tray 18, based on a control signal outputted from the main CPU 41. The coin detecting portion 67 is provided inside the coin payout exit 19, and outputs an input signal to the main CPU 41 in the case of detecting a payout of the predetermined number of coins from the coin payout exit 19.

The graphic board 68 controls an image display to the upper image display panel 33 and the lower image display panel 16 serving as an output device, based on a control signal outputted from the main CPU 41. To the lower image display panel 16, there are displayed the objects 71 and the targets 72. To the number-of-credits display portion 31 of the lower image display panel 16, there is displayed the number of credits stored in the RAM 43. To the number-of-payouts display portion 32 of the lower image display panel 16, there is displayed the number of coins to be paid out.

The graphic board 68 is provided with a VDP (Video Display Processor) that generates image data based on a control signal outputted from the main CPU 41, a video RAM that temporarily stores the image data generated by the VDP, and the like. It should be noted that image data used in generation of the image data by the VDP is included in a game program, which is read from the memory card 53 and stored in the RAM 43.

The bill validator 22 not only discriminates a regular bill from a false bill, but also accepts the regular bill into the cabinet 11. When accepting the regular bill, the bill validator 22 outputs an input signal to the main CPU 41 based on a face amount of the bill. The main CPU 41 stores in the RAM 43 the number of credits corresponding to the face amount of the bill transmitted with the input signal.

The ticket printer 35 prints on a ticket, based on a control signal outputted from the main CPU 41, a barcode formed by encoding data such as the number of credits stored in the RAM 43, date and time, an identification number of the slot machine 10, and outputs the ticket as the ticket 39 with a barcode. The card reader 36 reads data from a smart card and transmits the data to the main CPU 41, and writes data onto the smart card based on a control signal from the main CPU 41. The key switch 38S is provided on the keypad 38, and transmits a predetermined input signal to the main CPU 41 when the keypad 38 is operated by the player. The data display 37 displays data read by the card reader 36 and data inputted by the player through the keypad 38, based on a control signal outputted from the main CPU 41.

The door PCB 80 is connected with a control panel 20, a reverter 21S, a coin counter 21C, and a cold cathode tube 81. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. The respective switches 23S to 27S output input signals to the main CPU 41 when each of the buttons 23 to 27 corresponding thereto is operated by the player.

The coin counter 21C is provided inside the coin receiving slot 21 and discriminates a regular coin from a false coin inserted into the coin receiving slot 21 by the player. Coins other than regular coins are discharged from the coin payout exit 19. Further, when detecting a regular coin, the coin counter 21C outputs an input signal to the main CPU 41.

The reverter 21S operates based on the control signal outputted from the main CPU 41, and distributes a coin recognized by the coin counter 21C as the regular coin into a cash box (not shown) or the hopper 66, which are disposed in the slot machine 10. Namely, when the hopper 66 is filled with coins, a regular coin is distributed into the cash box by the reverter 21S. On the other hand, when the hopper 66 is not filled with coins, a regular coin is distributed into the hopper 66. The cold cathode tube 81 functions as a backlight installed on a rear face side of the lower image display panel 16 and the upper image display panel 33, and lights up based on a control signal outputted from the main CPU 41.

Next, processing executed on the slot machine 10 will be described.

The main CPU 41 reads and executes a game program to progress a game.

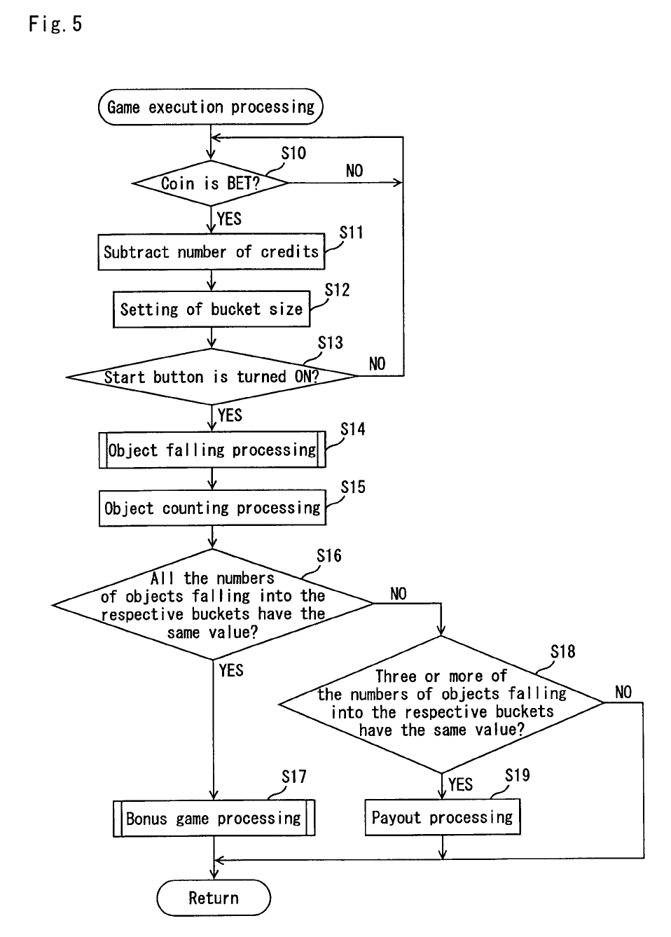

FIG. 5 is a flowchart showing a subroutine of game execution processing.

In the game execution processing, first, the main CPU 41 determines whether or not a coin has been BET (step S10). In this processing, the main CPU 41 determines whether or not to have received an input signal outputted from the 1-BET switch 26S when the 1-BET button 26 is operated, or an input signal outputted from the maximum BET switch 27S when the maximum BET button 27 is operated. When determining that a coin has not been BET, the main CPU 41 returns the processing to step S10.

On the other hand, when determining in step S10 that a coin has been BET, the main CPU 41 executes processing for making a subtraction from the number of credits stored in the RAM 43, according to the number of BET coins (step S11). It should be noted that, when the number of BET coins is larger than the number of credits stored in the RAM 43, the main CPU 41 does not execute the processing for making a subtraction from the number of credits stored in the RAM 43, and the processing is returned to step S10. When the number of BET coins exceeds an upper limit of the number of coins that can be BET in a single game (50 in the present embodiment), the main CPU 41 does not execute the processing of making a subtraction from the number of credits stored in the RAM 43, and the processing is proceeded to step S12.

In step S12, the main CPU 41 sets the size of the bucket of the targets 72 according to the number of coins BET in step S10. Namely, the larger the number of BET coins becomes, the larger the size of the bucket of the targets 72 is set. After the processing of step S12 ends, the main CPU 41 proceeds the processing to step S13.

In step S13, the main CPU 41 determines whether or not the start button 23 has been turned ON. In this processing, the main CPU 41 determines whether or not to have received an input signal outputted from the start switch 23S when the start button 23 is pressed.

When determining that the start button 23 has not been turned ON, the main CPU 41 returns the processing to step S10. It should be noted that, when the start button 23 is not turned ON (e.g. when a command to end the game is inputted without the start button 23 having been turned ON), the main CPU 41 cancels a result of the subtraction acquired in step S11.

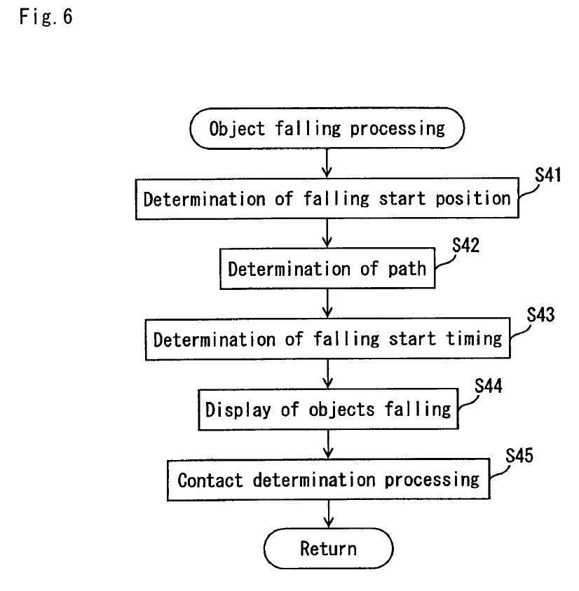

On the other hand, when determining in step S13 that the start button 23 has been turned ON, then the main CPU 41 executes object falling processing (step S14). In the object falling processing, the main CPU 41 executes an object falling program stored in the RAM 43 to determine a falling mode of the objects 71. This processing will be described in detail later using FIG. 6. In the present embodiment, the case is described in which the number of game media to be paid out is determined by executing the object falling processing. However, in the present invention, for example, the number of game media to be paid out may be determined first and then the falling mode of the objects 71 may be determined based on the determined number of game media to be paid out.

The main CPU 41 then executes processing for displaying, to the lower image display panel 16, an image in which the numbers of accumulated objects 71S having entered the respective targets 72a to 72e and being accumulated therein are counted (step S15). At this time, the image shown in FIG. 1B is displayed to the lower image display panel 16.

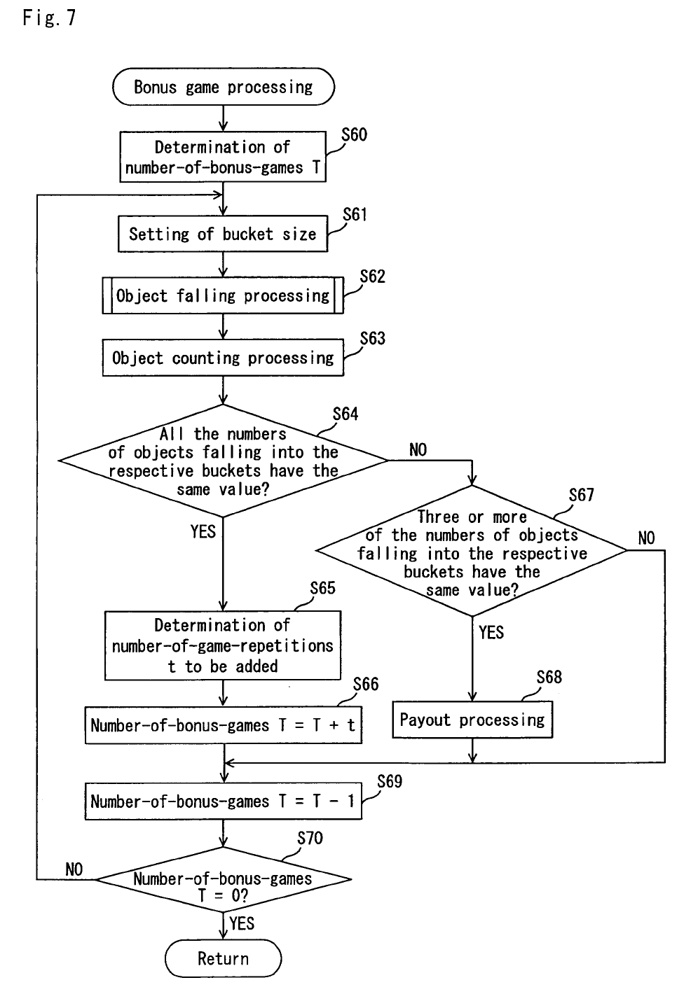

Next, the main CPU 41 determines whether or not all of the numbers of accumulated objects 71S having entered the respective targets 72a to 72e and being accumulated therein have the same value (step S16). When determining that all of the numbers of accumulated objects 71S having entered the respective targets 72a to 72e and being accumulated therein have the same value, the main CPU 41 reads from the RAM 43 a program for executing a bonus game to execute bonus game processing (step S17), and then ends the present subroutine. The bonus game processing will be described in detail later using FIG. 7.

When determining that the not all of the numbers of accumulated objects 71S having entered the respective targets 72a to 72e and being accumulated therein have the game value (step S16: NO), the main CPU 41 determines whether or not a prize has been established, i.e., whether or not three or more of the numbers of accumulated objects 71S among the numbers of the accumulated objects 71S having entered the respective targets 72a to 72e and being accumulated therein have the same value (step S18). When determining that a prize has been established, the main CPU 41 pays out coins corresponding to the number of inserted coins and the number of accumulated objects 71S (step S19), and ends the present subroutine.

Also, when a prize has not been established (step S18: NO), the main CPU 41 ends the present subroutine.

FIG. 6 is a flowchart showing a subroutine of the object falling processing called and executed in step S14 of the subroutine shown in FIG. 5. This processing is processing executed by the main CPU 41 executing the object falling program stored in the RAM 43.

First, the main CPU 41 determines a falling start position of each object 71 (step S41). Namely, a random number, which corresponds to a transverse coordinate position, is selected out of a predetermined numeric range by executing a predetermined random number generation program.

Next, the main CPU 41 determines a path of each object 71 (step S42). The path of each object 71 is determined by selecting one path pattern out of path patterns pre-stored in the object falling program.

The main CPU 41 then determines falling start timing of each object 71 (step S43). Thereafter, the main CPU 41 fall-displays each of the objects 71 based on the falling start positions, paths, and falling start timing which are determined in steps S41 to S43 (step S44).

Next, the main CPU 41 executes processing for determining whether or not the outer circumference of each of the objects 71 has come into contact with the outer circumference of any of the targets 72a to 72e (step S45). In this processing, an object 71 the outer circumference of which is determined to have come into contact with the outer circumference of the targets 72 is accumulatively displayed inside the target 72 as an accumulated object 71S, and an object 71 the circumference of which is determined to have not come into contact with the circumference of any of the targets 72 is move-displayed toward the bottom of the screen and deleted.

After the processing in step S45 is completed, the main CPU 41 ends the present subroutine.

FIG. 7 is a flowchart showing a subroutine of bonus game processing called and executed in step S17 of the subroutine shown in FIG. 5.

In the bonus game processing, the main CPU 41 first determines the number of bonus games from the numbers between 10 and 25 based on a random number acquired by executing a predetermined random number generation program stored in the RAM 43 (step S60). The main CPU 41 stores in the RAM 43 the determined number of bonus games as data.

Subsequently, the main CPU 41 executes bucket-size setting processing (step S61), object falling processing (step S62), and object counting processing (step S63). The processing from steps S61 to S63 is substantially the same as those described using FIG. 5. The processing has been already described; therefore, a description thereof will not be given here.

Next, the main CPU 41 determines whether or not all of the numbers of accumulated objects 71S having entered the respective targets 72a to 72e and being accumulated therein have the same value (step S64). When determining that all of the numbers of accumulated objects 71S having entered the respective targets 72a to 72e and being accumulated therein have the same value, the main CPU 41 newly determines the number-of-game-repetitions t for the bonus game (step S65), and the determined number-of-game-repetitions t is added to the current number-of-bonus-games T (step S66). This increases the number of remaining bonus games when a bonus game is won during a bonus game. Specifically, for example, in the case in which the game shifts to 20 bonus games for the first time and 17 bonus games are won at the 12th bonus game of the 20 bonus games, 25 (20−12+17) bonus games are executed thereafter.

After the processing in step S66 is completed, the processing shifts to step S69.

When determining that not all of the numbers of accumulated objects 71S having entered the respective targets 72a to 72e and being accumulated therein have the same value in step S64, the main CPU 41 determines whether or not a prize has been established, i.e., whether or not three or more of the numbers of accumulated objects 71S among the numbers of accumulated objects 71S having entered the respective targets 72a to 72e and being accumulated therein have the same value (step S67). When determining that the prize has been established, the main CPU 41 pays out coins corresponding to the number of inserted coins and the number of accumulated objects 71S (step S68).

When the prize has not been established (step S67: NO) and after the processing in step S68 is completed, the processing shifts to step S69.

In step S69, the main CPU 41 reads the number-of-bonus-games T stored in the RAM 43 and subtracts 1 from a value of the read number-of-bonus-games T. Then, the main CPU 41 stores the number-of-bonus-games T resulted after the subtraction, into the RAM 43 again.

Next, the main CPU 41 determines whether or not the number-of-bonus-games T has reached the number of bonus games determined in step S60 (step S70); namely, it is determined according to whether or not the number-of-bonus-games T stored in the RAM 43 has become 0. When the number-of-bonus-games T is not 0, i.e., when determining that the number of executed bonus games has not reached the number of bonus games determined in step S60, the main CPU 41 returns the processing to step S61 and repeats the above-described processing. On the other hand, when the number-of-bonus-games T is 0, i.e., when determining that the number of executed bonus games has reached the number of bonus games determined in step S60, the main CPU 41 ends the present subroutine.

As described above, the slot machine 10 and a playing method thereof according to the present embodiment comprises: the lower image display panel 16 capable of displaying the plurality of objects 71 moving in the downward direction and the plurality of the targets 72 which are for determining whether or not the plurality of objects 71 have entered; and the mother board 40, the mother board 40 displaying the plurality of objects 71 and the plurality of targets 72 to the lower image display panel 16, the plurality of objects 71 displayed in a mode of moving in the downward direction, executing a determination whether or not each of the objects 71 have entered any of the targets 72, and providing an award according to the object accumulated in the respective targets 72. In addition, the mother board 40 determines the size of the targets 72 according to the number of BETs, such that the larger the number of BETs, the larger the size of the targets 72. Furthermore, the mother board 40 provides an award according to a combination of the objects 71 accumulated in the respective targets 72.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processing described in the present specification are to be executed by various types of devices, in principle. Further, other structures required for conducting each step will be apparent from the aforementioned description.

What is claimed as new and desired to be secured by Letters Patent of the United States is:

1. A slot machine comprising:
a display capable of displaying a plurality of objects moving in a predetermined direction, and a plurality of areas a contact determination of which with each of the plurality of said objects is executed; and
a controller,
said controller displaying the plurality of said objects and the plurality of said areas to said display, the plurality of said objects displayed in a mode of moving in the predetermined direction,
executing a contact determination between each of the plurality of said objects and any of the plurality of said areas, and
providing an award according to said object having come into contact with said area.

2. The slot machine according to claim 1,
wherein
said controller includes
determining a size of the plurality of said areas according to the number of BETs, such that the larger the number of BETs, the larger the size of the plurality of said areas.

3. The slot machine according to claim 1 or 2,
wherein
said controller includes
providing an award according to a combination of the plurality of said objects having come into contact with said area.

4. A slot machine comprising:
a display capable of displaying a plurality of objects moving in a predetermined direction, and a plurality of areas a contact determination of which with each of the plurality of said objects is executed; and
a controller,
said controller determining a size of the plurality of said areas according to the number of BETs, such that the larger the number of BETs, the larger the size of the plurality of said areas,
displaying the plurality of said objects and the plurality of said areas to said display, the plurality of said objects displayed in a mode of moving in the predetermined direction,
executing a contact determination between each of the plurality of said objects and any of the plurality of said areas, and
providing an award according to said object having come into contact with said area.

5. The slot machine according to claim 4,
wherein
said controller includes
providing an award according to a combination of the plurality of said objects having come into contact with said area.

6. A slot machine comprising:
a display capable of displaying a plurality of objects moving in a predetermined direction, and a plurality of areas a contact determination of which with each of the plurality of said objects is executed; and
a controller,
said controller determining a size of the plurality of said areas according to the number of BETs, such that the larger the number of BETs, the larger the size of the plurality of said areas,
displaying the plurality of said objects and the plurality of said areas to said display, the plurality of said objects displayed in a mode of moving in the predetermined direction,
executing a contact determination between each of the plurality of said objects and any of the plurality of said areas, and
providing an award according to a combination of the plurality of said objects having come into contact with said area.

7. A playing method of a slot machine comprising the steps of:
displaying, to a display, a plurality of objects in a mode of moving in a predetermined direction and also displaying a plurality of areas a contact determination of which with each of the plurality of said objects is executed;
executing a contact determination between the plurality of said objects and any of the plurality of said areas; and
providing an award according to said object having come into contact with said area, each of said steps conducted by a controller.

8. The playing method of a slot machine according to claim 7,
wherein
said controller includes
determining a size of the plurality of said areas according to the number of BETs, such that the larger the number of BETs, the larger the size of the plurality of said areas.

9. The playing method of a slot machine according to claim 7 or 8,
wherein
said controller includes
providing an award according to a combination of the plurality of said objects having come into contact with said area.

10. A playing method of a slot machine comprising the steps of:
determining a size of a plurality of areas according to the number of BETs, such that the larger the number of BETs, the larger the size of the plurality of said areas;
displaying, to a display, a plurality of objects in a mode of moving in a predetermined direction and also displaying the plurality of said areas a contact determination of which with each of the plurality of said objects is executed;
executing a contact determination between each of the plurality of said objects and any of the plurality of said areas; and
providing an award according to said object having come into contact with said area, each of the steps conducted by a controller.

11. The playing method of a slot machine according to claim 10,
wherein
said controller includes
providing an award according to a combination of the plurality of said objects having come into contact with said area.

12. A playing method of a slot machine comprising the steps of:
determining a size of a plurality of areas according to the number of BETs, such that the larger the number of BETs, the larger the size of the plurality of said areas;
displaying, to a display, a plurality of objects in a mode of moving in a predetermined direction and also displaying the plurality of areas a contact determination of which with each of the plurality of said objects is executed;
executing a contact determination between each of the plurality of said objects and any of the plurality of said areas; and
providing an award according to a combination of the plurality of said objects having come into contact with said area, each of the steps conducted by a controller.
